(19) United States
(12) Patent Application Publication
(10) Pub. No.: US 2006/0273565 A1
(43) Pub. Date: Dec. 7, 2006

(54) Gas bag

(75) Inventor: Thomas Britz, Bessenbach (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/445,427

(22) Filed: Jun. 1, 2006

(30) Foreign Application Priority Data
Jun. 7, 2005 (DE) 20 2005 008 939.7

(51) Int. Cl. B60R 21/235

(52) U.S. Cl. 280/743.1

(57) ABSTRACT

A gas bag for use in a vehicle occupant restraint system, comprises at least one wall or a wall part made of a fabric which is formed from fibres. The fibres comprise a polymer matrix and cellulose fibrils distributed in said polymer matrix.

### TECHNICAL FIELD

The invention relates to a gas bag for use in a vehicle occupant restraint system, with at least one wall or one wall part made of a fabric which is formed from fibres.

### BACKGROUND OF THE INVENTION

Gas bag modules are incorporated in vehicles in order to reduce the kinetic energy of the vehicle occupants in the case of a vehicle accident and to protect the vehicle occupants from impact onto hard interior parts of the vehicle, such as for example the steering wheel or the side lining of the vehicle doors. When a sensor arrangement, connected to the gas bag module, detects that the vehicle has had an accident, a propellant is activated, generally present in tablet form, inside the gas generator, which propellant burns under high pressure in the combustion chamber housing and thus generates a hot gas which is supplied to a gas bag within a few milliseconds and inflates it.

During the inflating of the gas bag, generally very high temperatures and pressures act on the gas bag fabric for a short period of time. In addition, particles contained in the hot gas can impinge on the gas bag fabric. Costly measures are necessary in order to protect the gas bag fabric from damage. Nowadays, therefore, gas bag fabrics of polyamide or polyester fibres are used, which are coated totally or partially with silicone or neoprene. However, these coated fabrics have a high weight per unit area and can not be folded well. For this reason, the gas bags for vehicle occupant restraint systems are being produced increasingly from uncoated fabrics. However, in these gas bags the wall parts which are under high thermal stress, such as the regions of the gas bag fabric adjoining the inflation opening, must be protected by special measures from damage caused by hot gases and particles.

It has already been proposed to provide the inner side of a gas bag with heat-absorbing agents such as, for example, a foil coating or other sacrificial materials. These sacrificial materials are melted or disintegrated by the hot gases flowing into the gas bag and are intended to protect the actual gas bag wall from damage in this way. Thus, for example, a gas bag is known from DE 198 30 149 in which sodium hydrogen carbonate powder is applied onto the inner wall of the gas bag fabric, which powder is decomposed by the action of the hot gases from a temperature of approximately 180 degrees C. with the formation of carbon dioxide. A gas bag in which a thermoplastic elastomer is applied onto the inner wall of the gas bag fabric is described in JP-A-05338092.

### SUMMARY OF THE INVENTION

It is an object of the invention to provide a gas bag in which a sufficient protection from the action of hot gases or particles is achieved without sacrificial layers or additional coatings of the gas bag fabric.

The gas bag according to the invention is provided for use in a vehicle occupant restraint system and comprises at least one wall or a wall part of a fabric which is formed from fibres. The gas bag is characterized in that the fibres comprise, or consist essentially of, a polymer matrix and cellulose fibrils distributed in said polymer matrix.

The cellulose fibrils distributed in the polymer matrix serve as a flame protection which is integrated into the gas bag fabric when a gas generator is activated. If the gas generator is activated when the vehicle has an accident, a hot gas which inflates the gas bag is generated in a combustion chamber of the gas generator. However, if the gas flowing out from the combustion chamber is too hot or if a local overheating of the gas bag fabric by hot gas or hot particles occurs, then the unmeltable cellulose fibrils which are distributed in the polymer matrix pyrolize and form a carbon layer on the gas bag fabric. However, this carbon layer has a high temperature resistance like graphite and thereby protects the gas bag fabric from the hot gas. Therefore, no fabric has to be used which is protected against damage through the impinging hot gases or particles by a coating or other technical measures. The uncoated fabrics are, in addition, more favourably priced and can be folded more easily owing to their better flexibility.

### DESCRIPTION OF PREFERRED EMBODINENTS OF THE INVENTION

Cellulose fibrils form the main component of the cell wall of wood and cotton and are responsible for the high tensile strength of cotton fibres and wood. The production of the cellulose fibrils can take place for example in accordance with the method described in DE 196 28 324, which is incorporated herewith by reference. In this method, the cellulose fibrils are extracted from the cellulose fibres by mechanical treatment such as milling, kneading or extruding. In addition to the releasing of the fibrils, the milling always leads to a certain shortening of the initial material. In the kneading and extruding processes, the disintegration of fibres into fibrils is based predominantly on friction. A shortening of fibrils occurs, if at all, to a far lesser extent than with milling.

The gas bag according to the invention is preferably formed from a fabric in which the cellulose fibrils are present in the fabric fibres in a proportion of 0.1 to 15 parts by weight per hundred parts by weight of the polymer matrix. In the polymer matrix, the cellulose fibrils bring about a considerable increase in the tensile strength of the gas bag fabric compared with a gas bag fabric of a pure polymer matrix. The polyamide which is usually used as the gas bag fabric can therefore also be replaced by another polymer which has less favourable tensile strength values than the polyamide. However, the dtex number of the polyamide fibres can also be reduced. Tex is the international designation of fineness for textile fibres and indicates the weight in grams per 1000 m run length. Dtex stands for the weight in grams with 10,000 m run length. The higher the dtex number, the coarser the fibre. In the yarns used for the production of the gas bag fabric, the polymer fibres according to the invention preferably have an individual thread fineness of up to 10 dtex, preferably between 1.5 and 3.5 dtex.

The cellulose fibrils preferably have an average diameter of approximately 2 to 100 nm and an average length of approximately 1 to 10 μm.

The ratio of length to diameter (aspect ratio) of the cellulose fibrils is preferably greater than 60. The aspect ratio is a measurement for the binding capacity of the fibrils with each other. If fibrils have a low aspect ratio, then the overlapping of the fibrils is low and the binding capacity is poor. Polymers with cellulose fibrils embedded therein, which have a high aspect ratio and thereby have a high binding capacity, usually have a particularly high tear strength.

Particularly preferably, the ratio of length to diameter of the cellulose fibrils is therefore greater than 200.

The polymer matrix is preferably selected from the group of thermoplastic polymers and thermoplastic elastomers, and particularly preferably from the group consisting of polyester, polyurea, polyurethane and polyamide.

The fibres of the gas bag fabric comprising the polymer matrix and the cellulose fibrils distributed in said polymer matrix are obtainable by generally known compounding and spinning techniques.

In addition, the gas bag fabric according to the invention is preferably uncoated. Uncoated gas bag fabrics are more favourably priced compared with coated fabrics and can be folded more easily owing to their better flexibility.

The gas bag according to the invention is provided in particular for use in a gas bag module for the driver's side of a vehicle occupant restraint system. However, the invention is not restricted to this usage; it can also be applied to other gas bag configurations, such as for example a passenger gas bag or a head/side gas bag.

1. A gas bag for use in a vehicle occupant restraint system, the gas bag comprising at least one wall or a wall part made of a fabric which is formed from fibres, characterized in that the fibres comprise a polymer matrix and cellulose fibrils distributed in said polymer matrix.

2. The gas bag according to claim 1, characterized in that said fibres comprise the cellulose fibrils in a proportion of 0.1 to 15 parts by weight per 100 parts by weight of the polymer matrix.

3. The gas bag according to claim 1, characterized in that the cellulose fibrils have an average diameter of approximately 2 to 100 nm and an average length of approximately 1 to 10 μm.

4. The gas bag according to claim 3, characterized in that the ratio of length to diameter of the cellulose fibrils is greater than 60.

5. The gas bag according to claim 3, characterized in that the ratio of length to diameter of the cellulose fibrils is greater than 200.

6. The gas bag according to claim 1, characterized in that the polymer matrix is selected from the group consisting of thermoplastic polymers and thermoplastic elastomers.

7. The gas bag according to claim 1, characterized in that the polymer matrix is selected from the group consisting of polyester, polyurea, polyurethane and polyamide.

8. The gas bag according to claim 1, characterized in that the fabric is uncoated.
